(19) United States
(12) Patent Application Publication
(10) Pub. No.: US 2005/0174233 A1
(43) Pub. Date: Aug. 11, 2005

(54) Portable personal emergency warning system

(76) Inventors: Michael Elton Kennedy, Victoria (CA); Michele Kennedy, Victoria (CA)

Correspondence Address: Diane Kneeland, 148 Pecos St., Cedar Creek, TX, 78612, US

(21) Appl. No.: 11/054,497

(22) Filed: Feb. 9, 2005

Related U.S. Application Data
(60) Provisional application No. 60/542,824, filed on Feb. 9, 2004.

(51) Int. Cl. G08B 1/08

(52) U.S. Cl. 340/539.1; 340/573.1

(57) ABSTRACT

A personal and portable emergency warning system, comprised of a unique emergency tonal sequence transmission means, and an emergency tonal sequence receiver. The receiver is for use by an individual user or for work spaces and is compact and easily transportable by the users anywhere. The receiver is powered by either AC or DC power and is adapted to work on either both 110 HZ and for international use, 220 HZ power sources, or alternatively a DC voltage battery power source. The receiver is adapted to receive local broadcasts in AM and FM mode as well as world wide frequency options. The receiver is coupled to a microprocessor capable of recognizing the emergency tonal sequence and amplifying it to alert the user. The microprocessor controls the operating functions of the receiver. The unique proprietary tonal sequence is broadcast by a local station that participates in the system by purchasing or subscribing to the tone.

### BACKGROUND

1. Field of the Invention

This invention relates to emergency warning systems, specifically to a personal portable emergency device and means to activate it to provide an audible warning to the user.

2. Description of Prior Art

Modern living and travel necessitates taking a certain amount of predictable and unpredictable risk both of a voluntary and non-voluntary nature. For example, travel to unknown cities or countries poses the risk of crime and terrorism. Being in areas known for their severe and unpredictable weather events or seismic events creates the risk of personal injury or loss if such an event occurs.

Working or residing permanently or temporarily in a high office tower poses the risk of being stranded in the event of a power outage. Business and vacation travelers are often exposed to these events and the risks they entail. Nonetheless, such individuals continue to travel and accept these risks as a part of doing business or in exchange for unique experiences understanding that these risks cannot be eliminated, or in many cases, not even mitigated.

There are a number of examples whereby means to reduce the risk that individuals face at home or when traveling domestically or abroad have been attempted. Warning devices that are radio receivers adapted to receive signals from continually broadcasting transmitters are described in U.S. Pat. No. 6,493,633 to Baron (2002). However, the device described by Baron is basically a signal receiver and transmitter, and is not suited for providing an individual a variety of threat warnings broadcast by local stations. Additionally, Baron relies on being able to receive and transmit communications, and such abilities may be severely compromised in many situations. Another type of personal warning device is described in U.S. Pat. No. 6,518,878 to Skoff (2003). Skoff teaches a device that is a warning system adapted to emit a warning signal to prompt evacuation from a threatened building. The Skoff device is adapted to detect a plurality of emergency conditions such as fires or seismic events and output a desired and preprogrammed response. In accordance with a preferred embodiment of the Skoff invention, there is a warning system comprising a central control unit and a plurality of local units connected to the central control unit, each of the local units having a plurality of input trips and a plurality of programmable responses thereto; the plurality of input trips including a disconnect trip to indicate that the central control unit or connection thereto has failed. Such a device is better suited for wide area alerts, such as might be necessary in a school building. Skoff is not suited for the localized conditions that an individual might face in his or her hotel room in a foreign country.

Therefore, in so far as I am aware, there exists no system that comprises a portable and personal emergency warning device suitable for use by individuals that provides a broadcast warning from participating radio stations of a pending or occurring event having a risk for personal harm or loss.

### SUMMARY

The present invention is a system comprising a plurality of local radio stations cooperating to broadcast a predetermined emergency tone and an individual use portable apparatus adapted to receive the emergency tone and alert the user. The device includes a portable radio receiver capable of AC and DC operation and adapted to receive and recognize a universal emergency tonal sequence transmitted by a local radio station. This universal tonal sequence would allow the owner of a device to use it in any local area which had a participating radio station simply by adjusting the tuner to that station. Such emergency tonal sequences would be broadcast under the authority of a public body such as the police department in the event of an occurring or impending emergency situation with potential to cause harm or loss. These emergency situations include power blackouts, severe weather events such as tornadoes, seismic events, Amber Alerts and terrorism alerts. Once activated the device alerts the user to the emergency situation and continues to receive radio broadcasts from the local radio station. The local radio station purchases or subscribes to the predetermined emergency tonal sequence and in so doing becomes part of the system. In this way, a network of participating stations can be involved in the system thereby providing a broad area of emergency event warning for the user, completing the link from every level of authority to every person who wants it, immediately. For participating stations, which are 24 hour broadcast stations but are not staffed at night (automated programming), local police would have a touch tone dial-in method to broadcast emergency messages.

The radio receiver is adapted to receive local broadcasts in the AM and FM broadcast modes. A compact speaker is included for audible output from the radio receiver. The radio receiver is coupled to a microprocessor capable of controlling the operating functions of the radio such as tuning and volume control. The microprocessor is preprogrammed to detect the audible emergency tone sequences transmitted by local radio stations. The device then amplifies these signals into an emergency tone that is audible to the user. The invention also includes a plurality of bright white LEDs that activates with the emergency tone to provide a visible as well as audible emergency signal.

A second warning aspect of the invention includes a barometric sensor. The barometric sensor is coupled to the microprocessor through an analog to digital signal converter. Its purpose is to detect the unique pressure profile of a tornado in immediate proximity to the user. Tornado pressure profiles are well known, and prior to a tornado striking a particular area, it is known that barometric pressure drops precipitously giving only seconds of warning. The microprocessor of the invention is adapted to detect this pressure profile, and upon detection, trigger an audible warning tone to give the user time to seek cover or move away from windows or doors that may shatter. The emergency LEDs on the device will be actuated to provide visible warning to the user. In this way, should a local radio station broadcast a tornado warning, the device can provide an additional warning to the user if the tornado is in close proximity.

A third security aspect of the invention is sufficient battery capacity to illuminate bright LEDs so as to provide illumination for the user during a loss of AC electrical power. With the device plugged into an electrical wall socket, a power blackout will cause the radio receiver to automatically activate to receive a local broadcasting station to receive emergency notifications. The LEDs will also illuminate and provide sufficient illumination for movement, say in a darkened room or hallway in order to escape or avoid hazards, such as broken glass. Once the invention is removed from an AC wall socket, the device will continue to operate on internal battery power. Modern batteries for devices such as the invention are small and capable of providing adequate power for the radio receiver and illumination features of the invention for several hours. The alert will also make people aware of other possible consequences of power failure at night, such as alarm clock or home intrusion alarm failures.

A fourth security aspect of the invention is a motion sensor adapted to detect intruders by infrared detection means. In this mode, the device may be plugged into an AC wall socket that provides adequate scanning exposure for the infrared detection means for a home hallway, or alternatively, sit upon a hotel bedside table facing entry points. Alternatively, if AC power is not available then the device can operate on internal DC power.

Accordingly there are several aspects, objects and advantages to the invention, such as: providing an improved emergency warning device for the user; providing means for warning the user of impending tornado strikes; providing an AC and DC powered, portable, compact means for receiving public emergency alerts broadcast by either AM or FM radio transmitters; provide an illumination device sufficient to provide escape or avoid injury during a power blackout; and provide for intruder detection. Another advantage of the invention is the integration of these aspects into a single device. A further advantage of the invention is the use of microprocessor technology to automate the functions of the device. Yet a further advantage is the adoption of modern battery storage devices to provide a reliable and durable source of DC power. Still other advantages and objects of the invention will be apparent from a study of the following description and accompanying drawings.

### DRAWING FIGURES

FIG. 1a is a front view of one embodiment of the invention.

FIG. 1b is a side view of one embodiment of the invention.

FIG. 1c is a top view of one embodiment of the invention.

FIG. 2 is a block diagram showing the components of the invention

### REFERENCE NUMERALS IN DRAWINGS

10 receiver
12 body of the receiver
14 white light LED
16 white light LED
18 red/green LED
20 flat speaker
22 screen
24 front surface of body
26 DC power storage
28 batteries
30 battery compartment
32 back surface
34 electrical prongs
36 hinges for prongs
38 top surface
40 radio frequency display screen
42 radio frequency adjustment up
44 radio frequency adjustment down
46 device reset switch
48 MCU
50 antennae
52 emergency radio tone broadcast
54 radio station
56 radio receiver
58 digital interface
60 amplifier
62 audio output
64 connection between radio receiver and amplifier
66 power management means
68 battery recharging means
70 test/reset button
72 input sensor block
74 signal conditioner
76 digital signal
78 LED lights

### DESCRIPTION

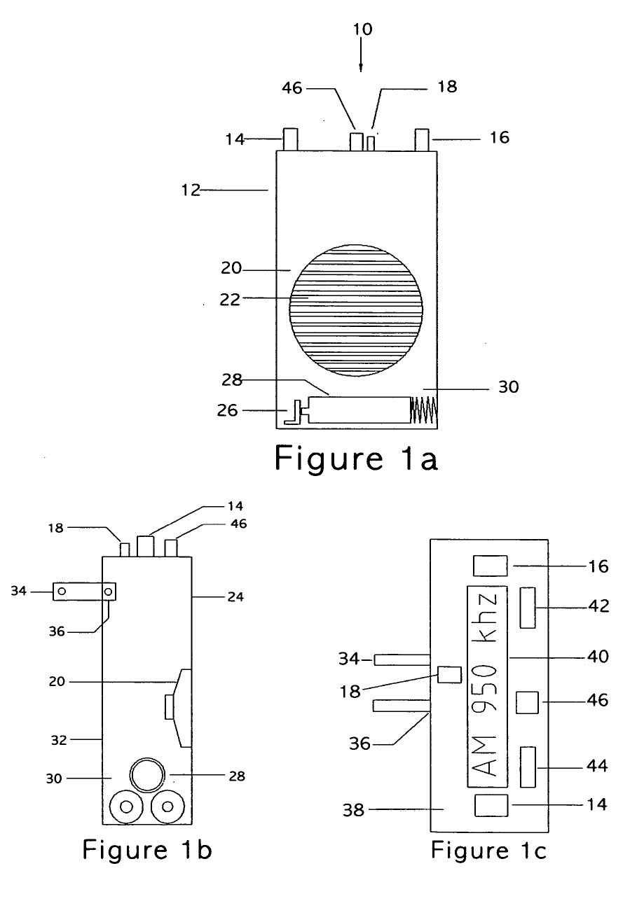

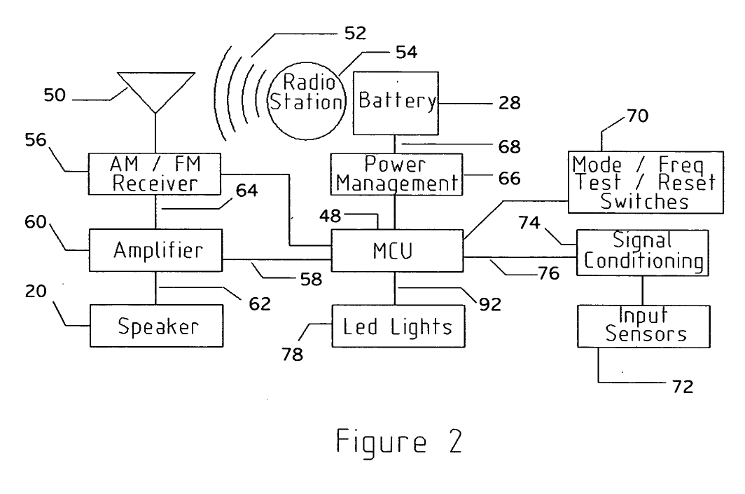

FIG. 1a illustrates the features of one embodiment of the receiver (10) of the invention. There is a body (12) adapted to contain and mount all operating components of receiver (10). The body has a height (h) about 5.125 inches high and a width (w) of about 2.75 inches. FIG. 1b illustrates the body as a having a thickness (t) of about 1.125 inches. These dimensions may vary but do not detract from the portability of the receiver. FIGS. 1a, 1b and 1c clearly illustrate the portable and compact nature of the receiver making it suitable for portable use and carriage on the person or in a small handbag or suitcase. The body mounts at least two (14) and (16) white light LEDs for emergency notification and illumination. An additional red/green LED (18) is provided to show on/off operation or fault indication. FIG. 1a illustrates a compact flat speaker (20) situated within the body (12) and broadcasting through a screen (22) in the front surface (24) of the body. The body can be fabricated in a number of ways and is made from a suitable thermoplastic material capable of molding. Illustrated in FIGS. 1a and 1b are DC power storage means (26) comprising batteries (28) held within a battery storage compartment (30). The batteries can be a plurality of conventional “A”, “AA” or “AAA” size batteries each rated at 1.5 VDC serially connected for an operating device voltage of 4.5 DC. However, it is to be understood that the batteries are used in the invention can be any suitable type of battery that provides adequate energy storage to permit DC operation for several hours without replacement. The batteries may also be rechargeable types such as NiCd with recharging means integrated into the device and receiving AC power from a suitable source such as a wall receptacle. FIG. 1b illustrates a side view of the invention showing the position of the various components of the invention (10). The speaker (20) is located at the bottom front surface (24) of the body (12). The illustration is not drawn to scale and a person skilled in the art will realize that such speakers can be extremely thin and compact while delivering a large audio output. A battery compartment (30) contains batteries (26). From the back surface (32) of the body (12) of the invention (10) there is shown a pair of AC electrical prongs (34) for insertion into an AC outlet. These prongs fold inwards on hinges (36) mounted to the base of the prongs so that when folded they are flush with the back surface (32) of the body (12). The AC input may be 110 VAC or 220 VAC and the prongs may be dual as shown or triple with a third grounding prong. Within the body (not shown) are power conversion means to convert the AC power to DC power of a required voltage to operate the invention. Referring to FIG. 1c there is shown a top view of the invention (10) illustrating the top surface (38). The red/green LED (18) and the illumination LEDs (14) and (16) are shown. The dual prong plug (34) is shown in its extended position for insertion into an AC socket. Mounted within the top surface (38) of the body (12) of the invention (10) is a flush mounted digital radio frequency display screen (40). In FIG. 1c the display shows the modulation of the radio transmitter and the frequency of the reception. The display can also be programmed to show on/off modes, signal strength, date/time, battery strength and a variety of other useful information for the individual. Radio control features are located on the top surface (38) such as radio frequency adjustment up (42) or down (44) and a device reset switch (46) to move the device from an alarming mode to a pre-alarm state. Referring now to FIG. 2 there is shown a block diagram of the components of the invention and their relationship. Of principal importance to the invention is a microcontroller unit (MCU) (48) that controls and coordinates the functions of the invention. The microcontroller (48) is adapted to receive and process information received by the various input devices of the invention. For example, the MCU will include several peripheral devices and functions such as an asynchronous communication means; analog to digital conversion means: timing means; radio output amplification means; barometric pressure monitoring means and power management control means.

The radio receiver means includes an antennae means (50) internal to the body (12) of the invention (10). The antennae means is a type typically found in modern portable radios and is configured to receive transmissions in the AM and FM broadcast modes. The antennae will receive emergency tone broadcasts (52) transmitted by the participating radio stations (54). The antennae means (50) is operatively connected to the radio receiver means (56) that is adapted to decode AM and FM transmissions. The MCU (48) controls a variety of functions of the radio receiver such as volume control and automatic on/off functions. The MCU (48) will monitor radio reception by means of a digital interface (58) seeking the predetermined emergency tones broadcast by the radio transmitter. The radio station will have a copy of the emergency tones on a purchase or subscription basis. If such tones are detected, the MCU will cause the device to change status from a monitoring mode to an active or alert mode. In the alert mode and by way of digital interface (58) the MCU will direct amplifier means (60) to amplify the broadcast emergency tone and direct audio output (62) to speaker (20) in order to alert the user. In the monitoring mode the amplifier means (60) may be muted by the MCU through digital interface (58). In an alternative operating mode, the radio receiver may act as a normal radio and play broadcasts through the amplifier (60) by way of connection (64). The MCU has automatic on/off control features to activate the radio receiver during an emergency tone broadcast if the receiver happens to be dormant so that the user is aware of the nature of the emergency. The radio receiver/tuner is comprised of active and passive components and integrated circuits (ICs) mounted on a PCB and surrounded by RF shielding material (not shown).

Also included in the receiver (10) is power management means (66) adapted to control power consumption of the invention. Power management means (66) is adapted to convert 110 AC or 220 AC into suitable DC voltage to operate the invention. The power management means also recharges (68) rechargeable batteries (28). Any transfer between AC and DC operating modes of the invention is controlled by the MCU in seamless fashion.

The test/reset button (70) permits the individual user to direct the MCU (48) to reset the invention after an alert has been triggered or, alternatively, test the functions of the device. The MCU has a pre-programmed test routine that will test the various aspects of the invention.

The input sensor block (72) may contain a plurality of sensors such as barometric pressure sensing means or an infrared body heat detector means. The sensor block is operatively connected to a signal conditioner (74) to modify the analog signal to a digital signal (76) for input into the MCU.

LED block (78) contains the red/green LED and the illumination/warning white LEDs that are controlled by the MCU as required in an alert or fault notification mode.

### OPERATION OF THE INVENTION

Local radio stations will have copies of the universal emergency tonal sequence that will activate the device. The local radio stations will either subscribe to or purchase copies of the emergency tones. In the event of an emergency situation, the radio station may be directed by public authorities to transmit the emergency alert tones. The radio receiver on the personal device may be in a monitoring mode or in an active mode receiving normal radio broadcasts. In either mode, the MCU will recognize the emergency tones and activate the device to amplify and broadcast the emergency tones to the user and thereby alerting the user to an emergency situation. The MCU will also keep the radio receiver in an active mode so that the user may continue to receive news about the emergency. The tone may comprise three short and loud highly pitched tones or some other combination of tones. The initial tonal alert is followed by a three second claxon horn. This tonal alert claxon sequence is repeated twice in rapid succession.

1. A portable personal emergency warning system comprising
a. an emergency tone
b. an emergency tone transmitter, and
c. an emergency tone receiver.

2. The system of claim 1, wherein said emergency tone receiver comprises a body, said body including
a. radio transmission receiving means
b. microcontroller means adapted to recognize said emergency tone
c. a plurality of emergency sensor input means
d. power management means, and
e. emergency notification means.

3. The apparatus of claim 2, wherein said radio transmission receiving means comprises
a. antennae means adapted to receive AM and FM radio transmissions
b. a radio receiver adapted to receive and decode said AM and FM transmissions
c. radio receiver output amplification means, and
d. a speaker.

4. The apparatus of claim 3, wherein said microcontroller means is adapted to control said radio receiver, said radio receiver output amplification means, said power management means, said plurality of emergency sensor input means and said emergency notification means.

5. The apparatus of claim 2, wherein said power management means includes
a. AC power input means, and
b. DC power input means.

6. The apparatus of claim 2, wherein said plurality of emergency sensor input means includes
a. barometric detection means, and
b. infrared body heat sensing means.

7. The apparatus of claim 2, wherein said emergency notification means includes
a. visible notification means, and
b. audible notification means.

8. The apparatus of claim 2, wherein said emergency tone is a predetermined sequence of tones adapted to be recognized by said microcontroller, and further wherein the emergency tone is provided to local radio stations on a purchase or subscription basis.
